(19) United States
(12) Patent Application Publication
(10) Pub. No.: US 2026/0367941 A1
(43) Pub. Date: Nov. 19, 2026

(54) Multi-Application User Interface for Prioritizing Notifications

(71) Applicant: Google LLC, Mountain View, CA (US)

(72) Inventors: Tim Wantland, Pacifica, CA (US); Ryan Bryce Connolly, Sunnyvale, CA (US); Christina Buquid, Irvine, CA (US); Jeffery Weber, Longmont, CO (US); Gus Winkelman, Soquel, CA (US)

(73) Assignee: Google LLC, Mountain View, CA (US)

(21) Appl. No.: 19/475,850

(22) PCT Filed: Apr. 26, 2023
(86) PCT No.: PCT/US2023/066227

§ 371 Date: Oct. 16, 2025

(51) Int. Cl. G06F 9/451; G06F 9/54

(52) U.S. Cl. CPC G06F 9/451; G06F 9/542

(57) ABSTRACT

This document describes techniques and systems enabling a multi-application user interface for prioritizing notifications. The techniques and systems prioritize and display notifications from multiple software applications based on their importance, relevance, or user history. The techniques further enable users to easily access software applications and their notifications. By so doing, users may see significant time savings by avoiding the tedious task of switching between user interfaces for notifications as well as sifting through numerous insignificant notifications.

### BACKGROUND

Many users manage their software applications and notifications through an overview that displays recently viewed content. These systems often have limited functionality and are not designed to handle the growing number of software applications and notifications that users must manage. As a result, users struggle to keep track of their activities and may miss important notifications.

This background description is provided for the purpose of generally presenting the context of the disclosure. Unless otherwise indicated herein, material described in this section is neither expressly nor impliedly admitted to be prior art to the present disclosure or the appended claims.

### SUMMARY

This document describes techniques and systems enabling a multi-application user interface for prioritizing notifications. The techniques and systems prioritize and display notifications from multiple software applications based on their importance, relevance, or user history. The techniques further enable users to easily access software applications and their notifications. By so doing, users may see significant time savings by avoiding the tedious task of switching between user interfaces for notifications as well as sifting through numerous insignificant notifications.

For example, a method is described that receives, at a user interface application associated with at least a first and second software application, a set of notifications. The set of notifications includes one or more first notifications associated with the first software application and one or more second notifications associated with the second software application. The method prioritizes the set of notifications into a priority group, the priority group including two or more of the notifications in the set of notifications and excluding one or more of the notifications in the set of notifications. The method prioritizes based on a relation between and a disparate importance of notifications within the set of notifications. The method may then present or cause presentation of, through the user interface application and within a single region of the user interface, the priority group of notifications.

This document also describes computer-readable media having instructions for performing the above-summarized method and other methods set forth herein, as well as systems and means for performing these methods.

This summary is provided to introduce simplified concepts for a multi-application user interface for prioritizing notifications, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects of a multi-application user interface for prioritizing notifications are described in this document with reference to the following drawings. The same numbers are used throughout the drawings to reference like features and components.

FIG. 1 illustrates an example environment in which techniques for a multi-application user interface for prioritizing notifications can be implemented.

FIG. 2 illustrates an example of the user interface with five prioritized notifications set forth in FIG. 1.

FIG. 3 illustrates an example implementation of the user interface of FIG. 2.

FIG. 4 illustrates another example implementation of the user interface of FIG. 2.

FIG. 5 illustrates another example of the user interface with the five prioritized notifications set forth in FIG. 1 along with a sixth prioritized notification.

FIG. 6 illustrates an implementation of a user equipment, which includes a notification manager and user interface application of FIG. 1.

FIG. 7 illustrates an example method enabling a multi-application user interface for prioritizing notifications.

FIGS. 8, 9, and 10 illustrate various machine-learned training, models, and techniques.

### DETAILED DESCRIPTION

### Overview

This document describes techniques and systems for a multi-application user interface for prioritizing notifications. The techniques and systems prioritize and display notifications from multiple software applications using a machine-learned model, prior user history, importance, relevance, or user-selected preferences to manage software applications and their notifications. By so doing, the techniques enable users to access disparate software applications' notifications based on their priority.

Assume, for example, that a user has been preparing for an afternoon meeting with work colleagues by reading emails via a work email application and looking at prepared documents on a collaboration website. The user then takes a break before the meeting and opens another application to schedule a weekend event and then another application to answer personal emails. During the meeting, some questions about the work emails and documents come up, causing the user to go to the work email and collaboration website on the user's device to find previously viewed materials that can be used to answer the questions. Further assume that because of the passage of time, the user's intervening personal tasks, and the various applications used to accomplish them, the history of the meeting preparation has become obscured, deleted, or unavailable. In this example, and in many similar examples, the user's separate and disjointed applications do not enable the user to accomplish desired tasks and may even make accomplishing some tasks more difficult.

In contrast, consider the disclosed techniques, which prioritize notifications across disparate software applications. The techniques can provide a more-efficient and user-friendly way for users to access notifications by priority, thereby reducing the amount of time spent on reading through unimportant notifications.

Take, for instance, a user who uses several different software applications throughout the day to keep track of various work-related items. They have a social media application to schedule posts, a project management application to keep track of work progress, an email application to send work-related updates, and a customer relationship management application to track customer interactions. Throughout the day, the user receives notifications from each of these applications, but the user often finds it difficult to prioritize which notifications require their immediate attention. As a result, they may miss important notifications or spend time responding to less-important ones. However, with a system that prioritizes notifications across these disparate applications, the user may receive a notification that a work item is falling behind schedule, followed by a notification that a customer has submitted a support ticket related to work, and then a notification that a marketing email has a higher “open rate” than expected. This user interface application helps the user to quickly identify the most-important notifications and take action accordingly, leading to a more-efficient and effective workflow.

This is but one example of how the described techniques and devices may be used to manage software applications and prioritize notifications. Other examples and implementations are described throughout this document. The document now turns to an example operating environment, after which example devices, methods, and systems are described.

### Operating Environment

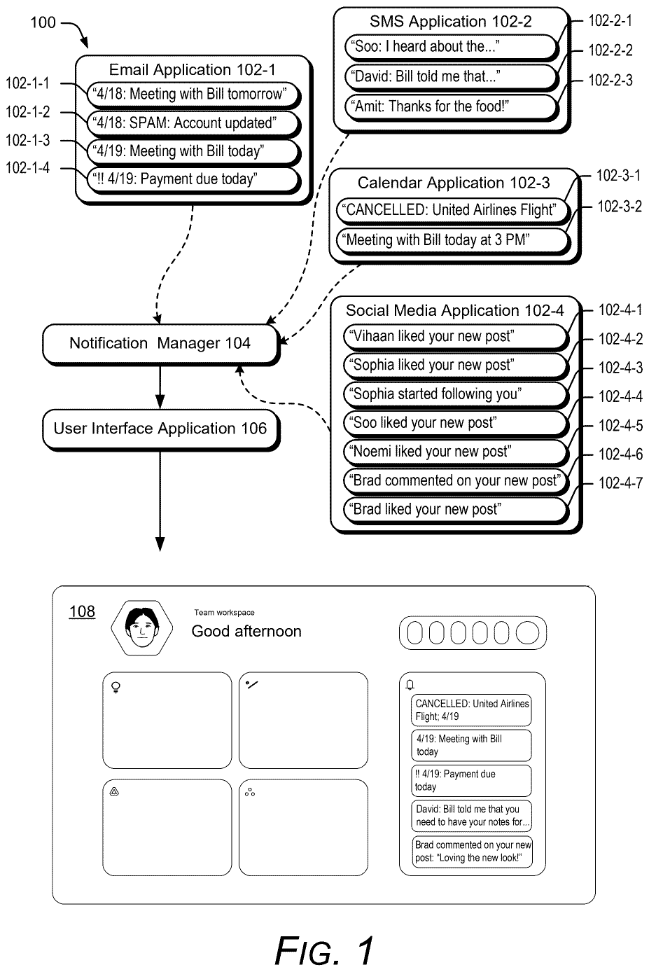

FIG. 1 illustrates an example environment 100 in which techniques enabling a multi-application user interface for prioritizing notifications can be implemented. The environment 100 includes applications 102, shown by example as an email application 102-1, a Short Messaging Service (SMS) application 102-2, a calendar application 102-3, a social media application 102-4, a notification manager 104, a user interface (UI) application 106, and a user interface 108. The user interface 108 provides an interface having information and/or functionality associated with more than one application, such as providing notifications from two or more applications and enabling interaction with notifications from two or more applications.

The environment 100 illustrates notifications associated with the applications 102, here showing the email application 102-1, the SMS application 102-2, the calendar application 102-3, and the social media application 102-4. The email application 102-1 has email notifications 102-1-1, 102-1-2, 102-1-3, and 102-1-4 (e.g., new emails, spam emails, unread emails, urgent emails). The SMS application 102-2 has SMS notifications 102-2-1, 102-2-2, and 102-2-3 (e.g., text messages, chats, instant messages). The calendar application 102-3 has calendar notifications 102-3-1 and 102-3-2 (e.g., cancelled events, meeting times, event reminders, birthday reminders). The social media application 102-4 has notifications 102-4-1, 102-4-2, 102-4-3, 102-4-4, 102-4-5, 102-4-6, and 102-4-7 (e.g., likes, tags, follows, comments).

In the environment 100, the notification manager 104 receives notifications from at least two of the applications 102. These notifications can be received, actively or passively, in groups over a time period or per application, one-at-a-time, and in various manners, such as through push notifications, API notifications, passive notifications, local notifications, and in-app notifications. As illustrated in FIG. 1, the notification manager 104 receives a set of sixteen notifications from the four applications 102.

The notification manager 104 prioritizes the received notifications into a priority group. The priority group can include two or more of the notifications from the received set of notifications and exclude one or more of the notifications from the set of notifications. The notification manager 104 determines priority, such as the illustrated priority group of five notifications from the set of sixteen notifications in FIG. 1, based on a relation between the notifications, a disparate importance of the notifications, similarity, chronology, a machine-learned model, or prior user selection.

Once prioritized, the notification manager 104, through the user interface application 106, presents the group of prioritized notifications in the user interface 108, here illustrated at a single region 110. In more detail and as illustrated in the example environment 100 of FIG. 1, the notification manager 104 receives the four email notifications 102-1-1, 102-1-2, 102-1-3, and 102-1-4 from the email application 102-1, the three SMS notifications 102-2-1, 102-2-2, and 102-2-3 from the SMS application 102-2, the two calendar notifications 102-3-1 and 102-3-2 from the calendar application 102-3, and the seven notifications 102-4-1, 102-4-2, 102-4-3, 102-4-4, 102-4-5, 102-4-6, and 102-4-7 from the social media application 102-4.

Thus, the notification manager 104 receives sixteen different notifications from four of the applications 102. The notification manager 104 can determine priority based on many factors, such as similar topics or more-recent notifications. For example, the email notification 102-1-1 and email notification 102-1-3 have the same subject, but the email notification 102-1-3 is more recent and describes a meeting occurring that day. Thus, the notification manager 104 prioritizes the email notification 102-1-3 over the email notification 102-1-1. The notification manager 104 reads the email notification 102-1-2 as spam and thus does not prioritize it, but the notification manager 104 marks the email notification 102-1-4 as urgent and thus prioritizes it and adds it to the priority group. The notification manager 104 receives the SMS notifications 102-2-1 and 102-2-3 and determines that they are not related to work and thus does not prioritize them (during the workday). The SMS notification 102-2-2 includes the name of someone that the user will be meeting with that day; thus, the notification manager 104 prioritizes it, thereby adding it to the priority group to be shown in the user interface 108. The notification manager 104 prioritizes the calendar notification 102-3-1 because it is a cancelled event that requires an action on the user's part. The calendar notification 102-3-2 is determined to have the same content as the email notification 102-1-3, but the user prefers email notifications over calendar notifications based on user history; thus, the notification manager 104 does not prioritize the calendar notification 102-3-2. The user has set the user interface 108 to show comment notifications from the social media application 102-4 (compared to “likes”); thus, the notification manager 104 prioritizes the social media notification 102-4-6 over the “like” notifications 102-4-1, 2, 4, 5, and 7.

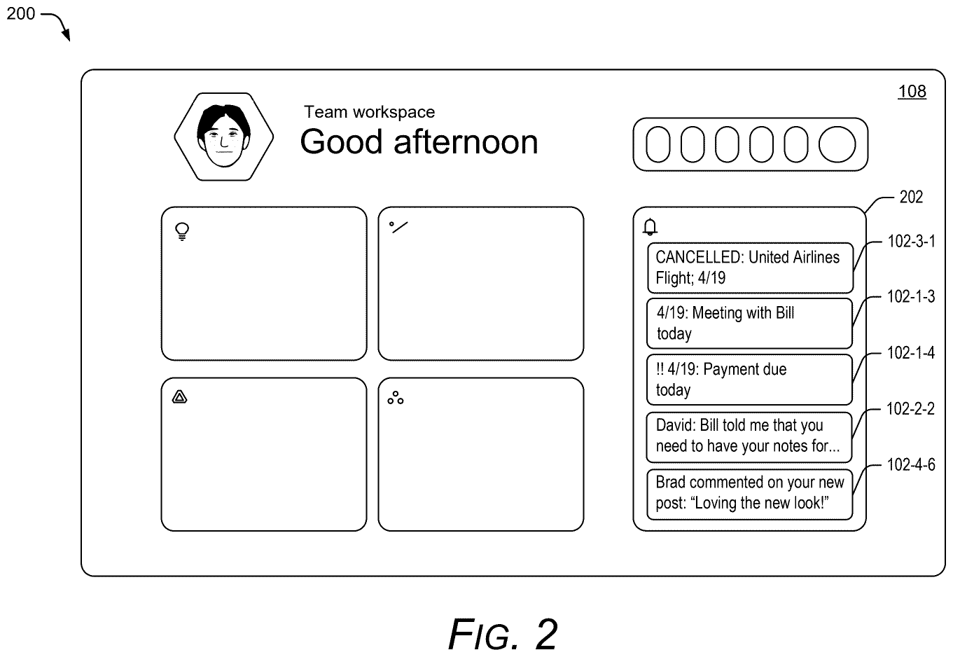

The notification manager 104 may cause the user interface application 106 to present the priority group of notifications in numerous manners, such as in widgets associated with the application from which the notification is received, or in a group that excludes lower-priority notifications, highlights higher-priority notifications but presents many or all of the notifications, or prioritizes the priority group in a list that includes the non-priority notifications of the set, such as by listing at the top of a list or using some other visual priority. In the illustrated example, the notification manager 104 directs the user interface application 106 to present the selected notifications for the priority group in the single region 110 of the user interface 108, described in more detail in FIG. 2. Instead of requiring the user to sift through the sixteen different notifications across the four different applications 102, the notification manager 104 presents only five notifications in the single region 110 of the user interface 108 that have been prioritized according to the user's needs.

In more detail, consider FIG. 2, which illustrates an example implementation 200 of the user interface 108 of FIG. 1. The example implementation 200 of FIG. 2 includes a priority notification region 202, the calendar notification 102-3-1, the email notification 102-1-3, the email notification 102-1-4, the SMS notification 102-2-2, and the social media notification 102-4-6.

In more detail, the user interface 108 of FIG. 2 displays the five prioritized notifications that the notification manager 104 received from the applications 102. In this illustrated example the priority notifications of the priority group are selected by the notification manager 104 from the 16 notifications received based on an action or response being required (rather than just informational), a chronological importance (e.g., which notifications are about something happening today vs next week), relatedness of notifications (e.g., repetitive or useful/informative), and user history.

A first notification displayed is the calendar notification 102-3-1, which indicates that the user's flight that day is cancelled. This calendar notification 102-3-1 is prioritized as the number one notification because it involves something happening today and the notification manager 104 determines that the user will have to make immediate changes to their schedule for that day, thus requiring immediate action from the user (e.g., changing flights, canceling other parts of a trip). A second notification displayed on the user interface 108 is the email notification 102-1-3, which tells the user that they have a meeting today, which is chronologically important. These factors in determining priority can be determined by user selection, user history, and/or machine learning. For example, the user may set their preferences of priority to show notifications that will require something (e.g., attending a meeting) from them on that day.

A third notification displayed to the user is the email notification 102-1-4. The email notification 102-1-4 has been indicated as urgent, which is used by the notification manager 104 to determine priority, and the notification manager 104 also determines both that the email notification 102-1-4 is legitimate (not spam, associated with a known or approved email address or company) and that it is chronologically important.

A fourth notification is the SMS notification 102-2-2, which mentions a certain name relating to the past email notification 102-1-3. In some instances, the user may want the user interface 108 to display notifications that immediately relate to a high-priority notification, such as the email notification 102-1-3; in such a case, the notifications are related or associated in some way. This relatedness can lower a priority or raise it-if the relatedness is repetitive, the priority can be lowered, but in this case, the relatedness is informative or useful for a higher-priority notification, here the past email notification 102-1-3.

A fifth and final notification in the presented priority group is the social media notification 102-4-6. This notification tells the user that they have a new comment on their recent social media post. As noted above, the user may explicitly prioritize types of notifications, or the notification manager 104 may determine, through user history and/or a machine-learned model, a priority that a particular user assigns to various types of notifications. Here assume that the user has a habit of selecting to see more information about notifications that are comments on social media (e.g., to read all of the comment itself that is not shown in the priority group presentation or previously through a listing of notifications by a user interface of the social media application associated with the comment type of notification).

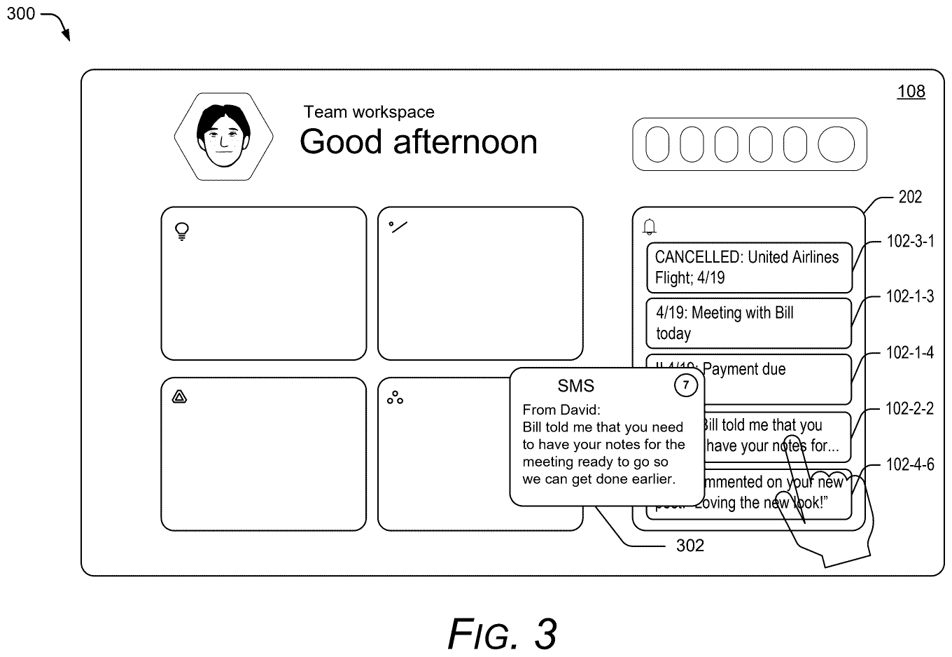

FIG. 3 illustrates an example implementation 300 of the user interface 108 of FIG. 1. In the example implementation 300 of FIG. 3, the user interface application 106 provides a notification pop-up region 302 responsive to a user selection (taps, hovers over) of a notification displayed in the priority group (e.g., displayed in the priority notification region 202). The notification pop-up region 302 here includes the entirety of the notification, although space constraints for long notifications or non-text content may affect an amount of text or content shown. For example, as illustrated in FIG. 3, the SMS notification 102-2-2 is selected and additional content associated with the notification is presented in the notification pop-up region 302 to present to the user the full text of the notification. The notification pop-up region 302 can pop up for any selected notification of the user interface 108. By enabling this type of expansion within the user interface 108, the user interface application 106 enables a user to quickly and easily see additional content for a notification. The user does not need to explicitly open the SMS application, alter the format of the user interface 108, or otherwise disturb the user's ease. The user simply taps or hovers over the priority notification, sees additional information associated with the selected notification, and then is able to move on to other tasks. The notification pop-up window 302 may automatically disappear responsive to a short period of time, responsive to a selection by the user of some other part of the user interface 108, or simply by the user ceasing to hover over or maintain a tap on the selected notification in the priority notification region 202.

As another example, the notification pop-up region 302 may display to the user the total number of notifications from an application associated with the selected notification, here the social media application 102-4. As seen in FIG. 3, when the SMS notification 102-2-2 is selected, the notification pop-up region 302 pops up with the full text of the notification. In a corner of the notification pop-up region 302, the total number of notifications from the SMS application 102-2 is displayed to the user. For example, if the user selects the social media notification 102-4-6 below the SMS notification 102-2, the notification pop-up region 302 may display the full text of the notification as well as show that there are seven unread social media notifications.

While illustrated as the notification pop-up region 302, other forms of an expanded portion of the user interface 108 may be used, such as making larger the selected notification within the single region 110 (e.g., the text of the notification pop-up region 302 being shown instead entirely within the single region 110 rather than a portion of it or over none of it (not shown in FIG. 3)).

While the example user selections include a tap, hover, and tap-and-hold, selection manners can include a mouse, a touchpad, a trackball, a pointing stick, a touchscreen, a graphics tablet, or gesture-based input devices.

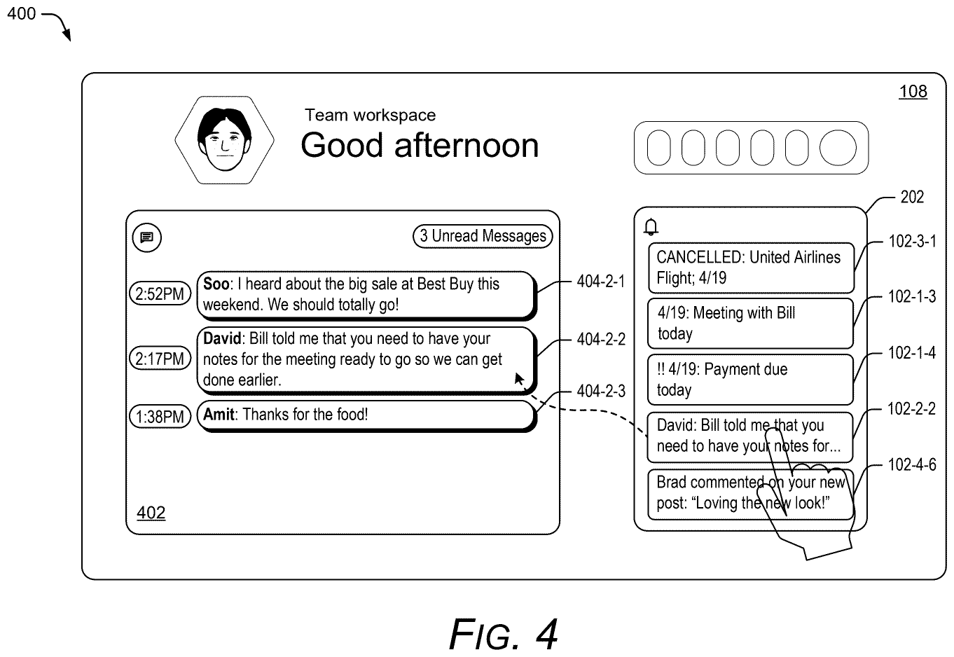

FIG. 4 illustrates an example implementation 400 of the user interface 108 of FIG. 1. In the example implementation 400 of FIG. 4, the user interface application 106 provides an application widget region 402 responsive to a user selection (e.g., taps, hovers over) of a notification displayed in the priority group (e.g., displayed in the priority notification region 202). The user interface application 106 may open (“launch”) an application associated with the selected notification, provide separate but similar functionality to the application without launching the application, or communicate with the application (assuming it is already launched) to provide functionality for the widget.

The example implementation 400 illustrates the application widget region 402 within the user interface 108. The notifications within the user interface 108 can be selected, moved, or pushed to enable one of the application 102 to open into the application widget region 402 presented to the user on the user interface 108. For example, a user may select a notification (e.g., SMS notification 102-2-2), which in turn opens the application widget region 402, which is then directed to present all of the notifications (unread, or read and unread, etc.) from that specific application. For example, the techniques here direct the application widget region 402 to present three unread SMS notifications, such as the SMS notifications 102-2-1, 102-2-2, and 102-2-3 of FIG. 1, in order of newest to oldest, but with additional or all of the content of each notification, shown at full-content notifications 404-2-1, 404-2-2, and 404-2-3 (respectively). While illustrated with the unread messages and full content, the application widget region 402 can be used to display the full content of the selected notification (or as much as is practicable) or in other manners. Note also that in this example the application widget region 402 replaces four other widgets shown in FIG. 1. The user interface application 106 may do so or forgo doing so based on various factors, such as a size of the application widget region 402 needed to display associated notifications or a single, full or near-full content notification, user history or selection for how they desire their user interface 108 to behave, or the existence of a widget for the application associated with the selected notifcation already being in the user interface 108. Thus, if one of the four widgets in FIG. 1 is associated with the application from which the selected notification was received, the full or larger content of the selected notification may simply be presented on the existing widget. Furthermore, the user interface 108 may highlight the application widget region 402 responsive to a selection or partial selection of a notification within the priority notification region 202. By so doing, a user may quickly understand where more information about the notification will be presented if the selection is completed (e.g., from a hover over to a tap).

In other aspects, the user interface application 106 enables the user to interact with notifications presented within the application widget region 402, which may include actions such as marking them as read or unread, deleting them, or replying to them, even in cases where the application is not launched for the associated notification. The application widget region 402 may also display associated metadata or other information, such as sender information, date and time of receipt, and associated attachments or links. The user interface application 106 may also facilitate a user's ability to switch between various applications and their associated notifications, which may be accomplished through use of tabs or a drop-down menu, for example. In these various examples for the user interface 108, the techniques enable a user to easily and simply move through notifications based on their priority, applications associated with those notifications, and even lower-priority notifications.

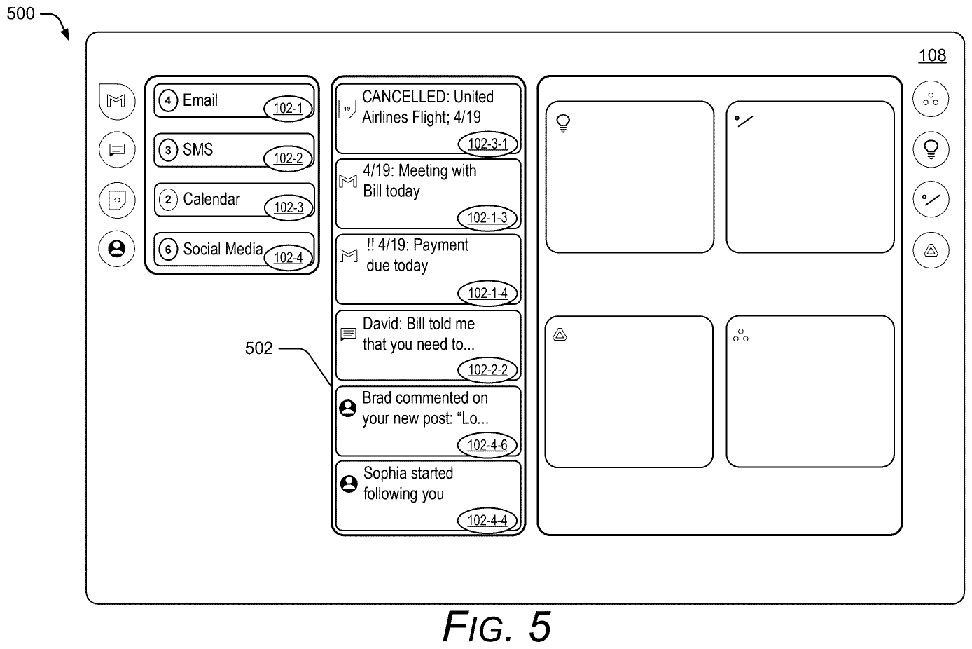

FIG. 5 illustrates another example implementation 500 of the user interface 108 from FIG. 1 with different regions and their arrangements. The system 500 includes a priority notification region 502 in which prioritized notifications from the four software applications 102 of FIG. 1 are located. Note that this priority notification region 502 is larger than the priority notification region 202 of FIG. 2, showing a priority group of six notifications. The user interface 108 can be altered by user selection or based on a user's history or a machine-learned model. For the example implementation 500, the techniques adds additional emphasis and space for notifications over those shown in FIG. 1, here shown with the priority notification region 502 being larger and centered. Further, the example implementation 500 includes a notification summary region 504, which presents names for applications from which notifications are received, here the “email” application 102-1, the SMS application 102-2, the calendar application 102-3, and the social media application 102-4. This notification summary region 504 also includes information about the set of notifications received and/or received and unread, here 15 of the prior 16 notifications, indicating that one of the notifications has been read and/or deleted. The additional priority notification of the priority group is shown at the social media notification 102-4-4, which indicates that a person named “Sophia” has started following the user.

As shown in FIGS. 1-5, many types and arrangements of user interfaces are enabled by the techniques, including larger or smaller notification regions, widgets, pop-up regions, and so forth, which are adjustable both by a user and through analysis of the user or other users' behavior. Through these user interfaces, however, a user is enabled to save time and add convenient to notification management.

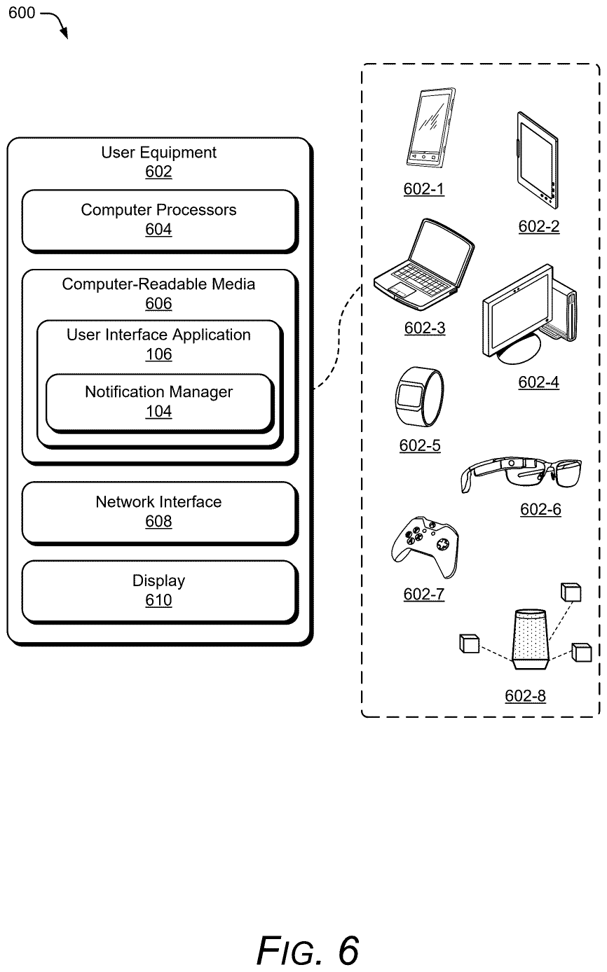

Consider FIG. 6, which illustrates an example implementation 600 of a user equipment (UE) 602 (including the notification manager 104 and user interface application 106) that can implement techniques for a multi-application user interface for prioritizing notifications. The UE 602 of FIG. 6 is illustrated with a variety of example devices, including a smartphone 602-1, a tablet 602-2, a laptop 602-3, a desktop computer 602-4, a computing watch 602-5, computing spectacles 602-6, a gaming system 602-7, and a home-automation and control system 602-8. The UE 602 can also include other devices, such as televisions, entertainment systems, audio systems, automobiles, drones, track pads, drawing pads, netbooks, e-readers, home security systems, and other home appliances. Note that the UE 602 can be wearable, non-wearable but mobile, or relatively immobile (e.g., desktops and appliances).

The UE 602 also includes one or more computer processors 604 and one or more computer-readable media 606, which includes memory media and storage media. Applications and/or an operating system (not shown) implemented as computer-readable instructions on the computer-readable media 606 can be executed by the computer processors 604 to provide some or all of the functionalities described herein, such as some or all of the functions of the notification manager 104 and user interface application 106 (shown within the computer-readable media 606, although this is not required, as server or remote techniques may be used in whole or in part).

The UE 602 may also include a network interface 608. The UE 602 can use the network interface 608 for communicating data over wired, wireless, or optical networks. By way of example and not limitation, the network interface 608 may communicate data over a local-area network (LAN), a wireless local-area network (WLAN), a personal-area network (PAN), a wide-area network (WAN), an intranet, the Internet, a peer-to-peer network, a point-to-point network, or a mesh network.

The UE 602 may also include a display 610. The UE 602 can use the display 610 to present the priority group of notifications to the user. The display 610 may be any example display showing the user interface 108 of FIGS. 1, 2, 3, 4, or 5.

The regions and functions described with relation to FIGS. 1-5 may be further divided and combined. In this way, different implementations of the UE 602 can be used to implement a multi-application user interface for prioritizing notifications. The example operating environment 100 of FIG. 1 and the detailed illustrations of FIGS. 2-5 illustrate but some of many possible environments and devices capable of employing the described techniques.

### Example Method

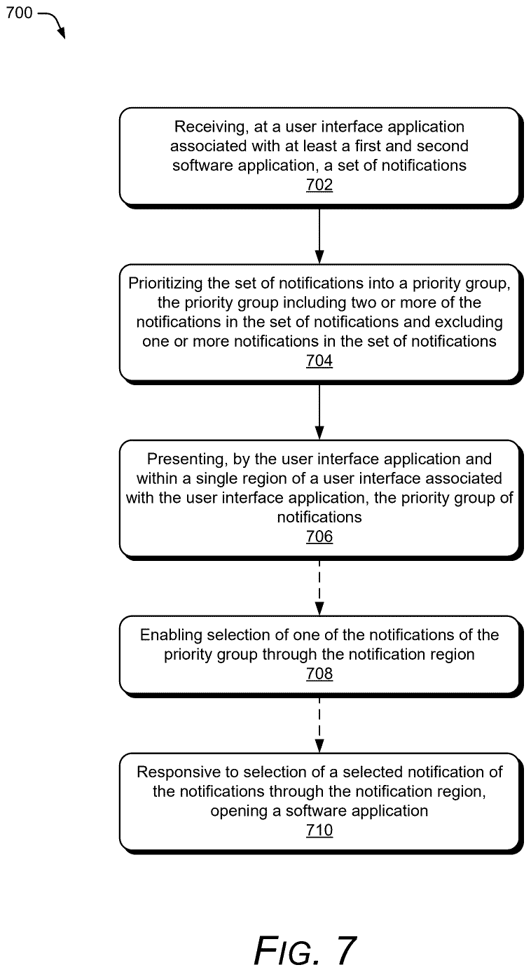

FIG. 7 depicts an example method 700 for techniques enabling a multi-application user interface for prioritizing notifications. The method 700 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example operating environment 100 of FIG. 1 or to entities or processes as detailed in other figures, reference to which is made for example only. The techniques are not limited to performance by one entity or multiple entities operating on one device.

At 702, a set of notifications are received at a user interface application, the set of notifications associated with at least a first and second software application. As seen in FIG. 1, the notification manager 104 receives notifications from at least two applications 102. As illustrated, four applications 102 have sixteen different notifications. The email application 102-1 has four notifications, the SMS application 102-2 has three notifications, the calendar application 102-3 has two notifications, and the social media application 102-4 has seven notifications. The notification manager 104 is configured to interact with multiple applications 102, such as by receiving the notifications over a time period as a group from each application 102, although they can come in separately and/or periodically. The notification manager 104 may receive notifications in different ways, including, but not limited to, push notifications, API notifications, passive notifications, local notifications, and in-app notifications.

At 704, the set of notifications are prioritized into a priority group. The priority group includes two or more of the notifications in the set of notifications and excludes one or more of the notifications in the set of notifications. The notification manager 104 determines priority based on a relation between notifications, a disparate importance of notifications, a machine-learned model, or prior user selection, such as the illustrated priority group of five or six notifications from a set of sixteen notifications (FIGS. 1 and 5, respectively).

For example, the notification manager 104 may prioritize based on relationships between the set of notifications. The set of notifications has a relation between notifications based on the notifications being related to a single project, such as a substance-based task associated with both the first and second applications. The notification manager 104, for example, can determine the single project based on a history of application usage by a user. For example, the application usage may indicate greater use of one of the first and second applications than the other, or greater use between other applications also associated with the described user interface and the set of notifications. Furthermore, the notification manager 104 may prioritize based on notifications being associated with a same work project, such as through analysis of metadata and/or text within the notifications indicating a relation to a topic or project, such as a work project that requires the user to travel and meet with a person named “Bill,” as the notifications share a common term, metadata, or person.

In other aspects, the notification manager 104 may prioritize based on the disparate importance of notifications within the set of notifications. The notification manager 104 determines the disparate importance based on a due date to respond, which is determined from within text of the notifications or metadata associated with the notifications.

In other instances, the notification manager 104 may prioritize the set of notifications into the priority group based on prior user selection, such as the user associating the first and second applications to a project or based on the user arranging the user interface 108 (e.g., arranging widgets into the user interface 108 for a work calendar application, a work email application, and a social media account associated with work). The user may arrange the user interface 108 by selecting widgets for presentation on a home page of the user interface 108, their size, and so forth. The widgets may be associated with the first and second applications (e.g., as illustrated in FIGS. 1 and 5). The notification manager 104 may also prioritize the set of notifications into the priority group based on a shared project name, common group of employees and/or vendors, or various metadata about some of the notifications.

The process of prioritizing the set of notifications eliminates some notification(s) from the set, leaving the priority group. The notification manager 104 may remove notifications from the set of notifications based on an age of a removed notification. The age of the removed notification may be older than one of the remaining notifications, and they may be related through a common group, task, or project or a single application of the first and second applications. For example, the notifications of the set of notifications may include an email, an SMS message or a text, information received through an application program interface (API), a push notification, a social-media like, a social-media mention, a tag, a calendar event, a missed video chat, or a missed phone call.

At 706, the priority group of notifications is presented by the user interface application and within a single region of a user interface. The priority group can be presented as shown in FIGS. 2, 3, 4, or 5. The priority group of notifications can be within the single region of the user interface or within a widget region (e.g., priority notification region 502 of FIG. 5). The user interface application occupies a substantial majority of a display of a mobile electronic device, such as a touch-sensitive display of a smartphone or tablet, and sufficient size with larger displays to cover multiple regions having at least one notification region.

At 708, the user interface application may enable selection, through the notification region, of one of the notifications of the priority group. Responsive to the selection of the selected notification of the notifications through the notification region, the notification manager 104 can open or access a software application associated with the selected notification (e.g., the notification was received, at operation 702, from the software application or a server entity associated with the software application). The user interface application 106 (as shown in FIG. 1) may cause the software application to open a notification user interface showing additional information for the notification, providing the additional information to the user interface application for presentation in another region (e.g., notification pop-up region 302 of FIG. 3). Furthermore, the user interface may cease to present the notification within the region commensurate with the presented additional information within the widget region (e.g., application widget region 402 of FIG. 4).

In aspects, a notification of the priority group of notifications is an email notification. The presented priority group of notifications may be a portion of an email associated with the email notification. Furthermore, responsive to the selection of the notification, the user interface may present an additional portion of the email. The additional portion of the email may be substantially all the text of the email, presented within an expanded portion of the user interface, a widget associated with an email service application and within the user interface, or a user interface of the email service application. In other aspects, a notification of the priority group of notifications may be an SMS notification, a social media notification, a task management notification, a productivity notification, a calendar notification, a document editing notification, a video conferencing notification, a phone call notification, or a collaboration update notification.

As noted above, the user interface can enable the selection of one of the notifications of the priority group through the single region, such as the priority notification region 202 in FIG. 2.

At 710, responsive to the selection of the notification, the user interface application directs a software application associated with the selected notification to be opened, launched, installed, accessed, or otherwise utilized or simulated. By so doing, the software application, or the user interface 108 acting as a simulation, is directed to open a notification user interface, such as the application widget region 402 of FIG. 4.

### Example Machine-Learned Training, Models, and Techniques

In other implementations, the notification manager 104 prioritizes the set of notifications into a priority group based on a machine-learned model, which is determined based on a history of prior user behavior, such as by a user of the user interface 108 and/or other users. The history of prior user behavior can be determined through user selection history. For example, the history of prior user behavior can be used to train the machine-learned model. The history of prior user behavior can include multiple users not associated with the user of the user interface. The history of prior user behavior also includes selection history indicating selections through other priority groups of other user interfaces associated with the user interface application.

For the purposes of this disclosure, a machine-learned model is any model that accepts an input, analyzes and/or processes the input based on an algorithm derived via machine-learning training, and provides an output. The model input (the set of notifications) can be analyzed or processed by the model to generate the model output (e.g., the prioritized group of notifications).

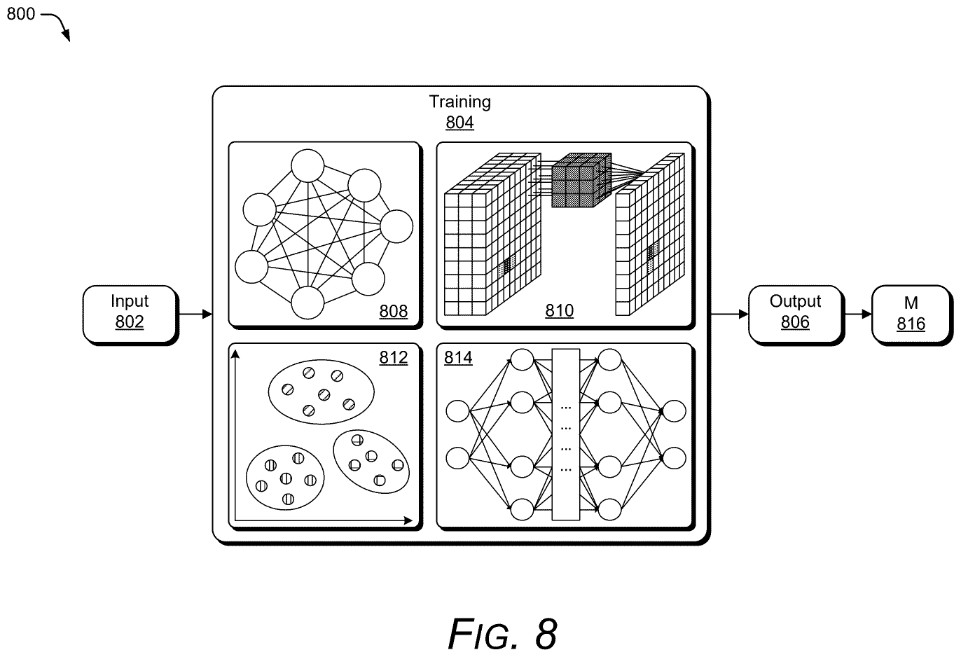

FIG. 8 represents an example machine-learning block diagram 800. An input 802 is fed into a training module 804, which processes the input 802. The training module 804 provides a prediction output 806. The prediction output 806 can represent a known correlation with the input 802, such as, for example, the prioritized notifications from the set of notifications. The training module 804 can include several specified ways of processing the input 802 and generating the output 806, including, but not limited to, a multilayer perceptron neural network (MLP) 808, convolutional neural networks (CNN) 810, k-means clustering 812, a Boltzmann machine 814, and others not illustrated, such as recurrent neural networks (RNN). The input 802, the training module 804, and the output 806 can be used to generate a machine-learned model M 816.

In some examples, the input 802 can be training input labeled with known output correlation values, and these known values can be used to optimize the output 806 in training using an optimization/loss function.

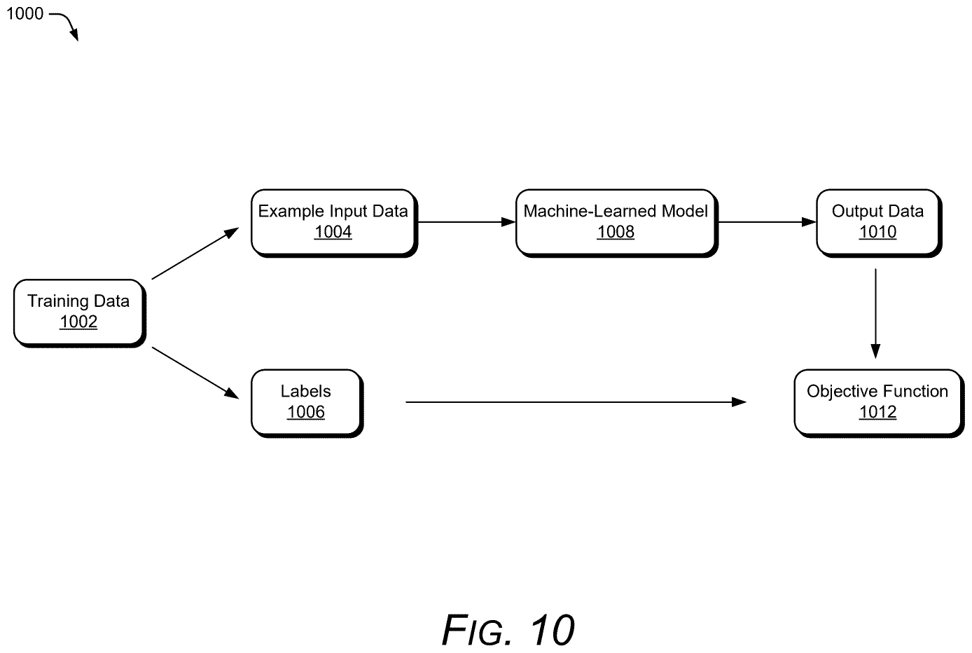

The machine-learning method disclosed involves collecting data about a user's history from various sources, including but not limited to user interactions with websites, mobile apps, and social media activities. Relevant features are then extracted from the collected data (e.g., for CNN), which involves selecting the most significant information that will be used to make predictions. For instance, features such as the user's interaction history with notifications, their location, and a time of day they are most active may be relevant. After extracting the features, an appropriate machine-learning algorithm is selected based on characteristics of the data and the type of problem being solved. A supervised learning algorithm may be utilized, where the model (e.g., machine-learned model 1008) is trained on labeled data (e.g., labels 1006 of FIG. 10). During training, the algorithm adjusts its internal parameters to minimize a difference between its predictions and actual importance levels of notifications in the training data. Once the model has been trained, it can be deployed to predict the importance of new notifications based on the user's history. These predictions can then be utilized to deliver crucial notifications to the user in a timely and relevant manner.

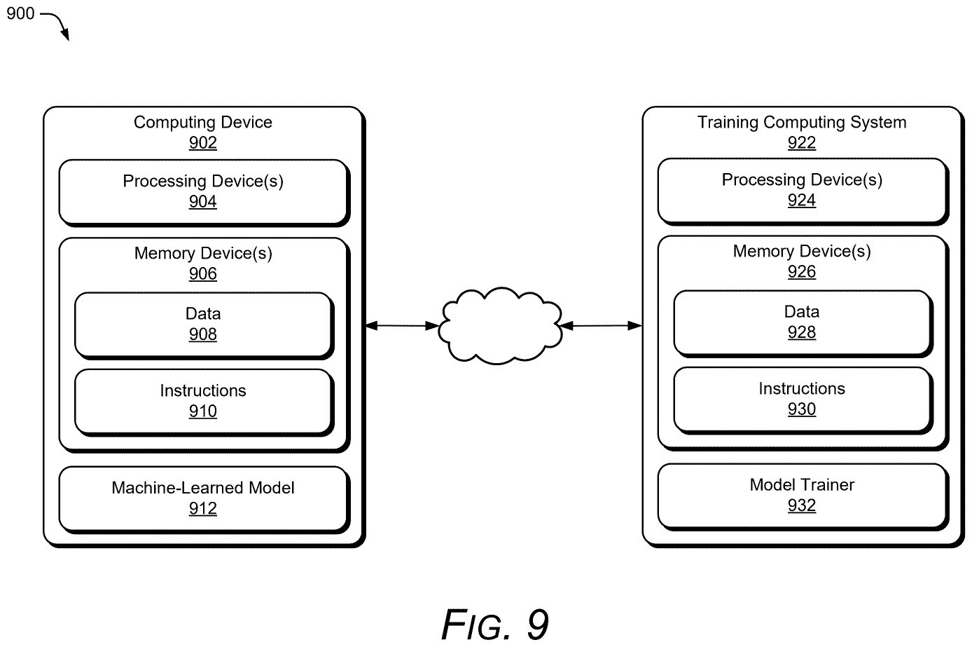

In some implementations, the machine-learned models described herein can be trained at a training computing system and then provided for storage and/or implementation at one or more computing devices, as described above. For example, a model trainer can be located at the training computing system. The training computing system can be included in or separate from the one or more computing devices that implement the machine-learned model. As one example, FIG. 9 illustrates a block diagram of an example computing device 902 having one or more processing devices 904, memory devices 906 having data 908 and instructions 910, and a machine-learned model 912 in communication with an example training computing system 922 having one or more processing devices 924, memory devices 926 having data 928 and instructions 930, and a model trainer 932.

In some implementations, the machine-learned model 912 can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

The model trainer 932 can perform centralized training of the machine-learned models (e.g., based on a centrally stored dataset) or decentralized training (e.g., distributed training or federated learning) to train, update, or personalize the machine-learned models.

The machine-learned models described herein can be trained according to one or more of various different training types or techniques. For example, the machine-learned models can be trained using supervised learning in which the machine-learned model are trained on a training dataset that includes instances or examples that have labels. The labels can be manually applied by experts, generated through crowdsourcing, or provided by other techniques (e.g., by physics-based or complex mathematical models). In some implementations, if the user has provided consent (e.g., for their selection history of notifications), the training examples can be provided by the user computing device. In some implementations, this process can be referred to as personalizing the model. In some instances, the models can be trained using unsupervised learning techniques, where the training data is not labeled, and correlations are found by the machine-learning training module 804 independent of explicit labels applied prior to the machine-learning training. Some examples may see a combination of supervised and unsupervised methods in the same machine-learning training.

As one example, FIG. 10 illustrates a block diagram of an example training process in which training data 1002, which includes example input data 1004 that has labels 1006, is used to train a machine-learned model 1008. The machine-learned model 1008 creates output data 1010 (e.g., the priority group of notifications). Training processes other than the example process depicted in FIG. 10 can be used as well, including processes that do not use labels 1006.

The machine-learned model 1008 can be trained by optimizing an objective function 1012. For example, in some implementations, the objective function 1012 can be or include a loss function that compares (e.g., determines a difference between) the output data 1010 generated by the model 1008 from the training data 1002 and the labels 1006 (e.g., ground-truth labels) associated with the training data 1002. For example, the loss function can evaluate a sum or mean of squared differences between the output data 1010 and the labels 1006. As another example, the objective function 1012 can be or include a cost function that describes a cost of a certain outcome or output data. Other objective functions 1012 can include margin-based techniques such as, for example, triplet loss or maximum-margin training.

### EXAMPLES

Various examples are described herein, including a first example method (example 1) that receives, at a user interface application associated with at least a first and second software application, a set of notifications. The set of notifications includes one or more first notifications associated with the first software application and one or more second notifications associated with the second software application. The method prioritizes the set of notifications into a priority group, the priority group including two or more of the notifications in the set of notifications and excluding one or more of the notifications in the set of notifications. The method prioritizes based on a relation between and a disparate importance of notifications within the set of notifications. The method may then present or cause presentation of, through the user interface application and within a single region of the user interface, the priority group of notifications.

Example 2: The method of example 1, wherein a notification of the priority group of notifications is an email notification and the presenting the priority group of notifications presents a portion of an email associated with the email notification, and further comprising, responsive to selection of the notification, presenting an additional portion of the email.

Example 3: The method of example 2, wherein presenting the additional portion of the email presents substantially all text of the email, the presenting within an expanded portion of the user interface, a widget associated with an email service application and within the user interface, or a user interface of the email service application.

Example 4: The method of example 1, wherein a notification of the priority group of notifications is an SMS notification and the presenting the priority group of notifications presents a portion of an SMS associated with the SMS notification, and further comprising, responsive to selection of the notification, presenting an additional portion of the SMS.

Example 5: The method of example 4, wherein presenting the additional portion of the SMS presents substantially all text of the SMS, the presenting within an expanded portion of the user interface, a widget associated with an SMS service application and within the user interface, or a user interface of the SMS service application.

Example 6: The method of example 1, wherein a notification of the priority group of notifications is a social media notification and the presenting the priority group of notifications presents a portion of a social media associated with the social media notification, and further comprising, responsive to selection of the notification, presenting an additional portion of the social media.

Example 7: The method of example 6, wherein presenting the additional portion of the social media presents substantially all text of the social media, the presenting within an expanded portion of the user interface, a widget associated with a social media service application and within the user interface, or a user interface of the social media service application.

Example 8: The method of any one of the preceding examples, wherein the set of notifications are received over a time period and through a push notification from the first and second software applications.

Example 9: The method of example 1, wherein the prioritizating the set of notifications into the priority group removes notifications from the set of notifications, remaining notifications of the set of notifications being the priority group.

Example 10: The method of example 9, wherein the removal of the notifications from the set of notifications is based on an age of a removed notification, the age being older than an age of one of the remaining notifications, the removed notification and the remaining notification related through a common group, task, or project or a single software application of the first and second software applications.

Example 11: The method of example 1, wherein the first software application is a calendar application, a first related notification is a calendar event associated with a project, the second software application is an information-generation application, and a second related notification is a change made, change requested, or approval requested notification for an information document of the information-gathering application that is associated with the first related notification.

Example 12: The method of example 1, wherein the first software application is a social media application, a first related notification is a new message, like, comment, follow, post, or tag of the social media application that is associated with a project, the second software application is a task management application, and a second related notification is a task reminder, task assignment, task update, or task comment associated with a task of the task management application that is associated with the first related notification.

Example 13: The method of example 1, wherein the first software application is an email application, a first related notification is a new email, email delivery failure, calendar invitation, or meeting reminder associated with a project, the second software application is a contact management application, and a second related notification is a new contact, contact deletion, contact update, or lead status associated with the first related notification.

Example 14: The method of example 1, wherein the first software application is an email application, a first related notification is a new email, email delivery failure, calendar invitation, or meeting reminder associated with a project, the second software application is a writing-enhancing application, and a second related notification is a sentence structure suggestion, tone and formality suggestion, or vocabulary enhancement suggestion associated with the first related notification.

Example 15: The method of example 1, wherein the first software application is a document editing application, a first related notification is an update, new comment, or changes made by other users associated with a project, the second software application is a writing-enhancing application, and a second related notification is a plagiarism alert, writing style suggestion, clarity and conciseness suggestion, or grammar and spelling error alert associated with the first related notification.

Example 16: The method of example 1, wherein the first software application is a customer relationship management (CRM) application, a first related notification is a customer activity or team activity alert associated with a project, the second software application is a user authentication application, and a second related notification is a login, security alert, or privacy alert associated with the first related notification.

Example 17: The method of example 1, wherein the first software application is a notes application, a first related notification is a reminder, collaboration update, or sync update associated with a project, the second software application is a mind-mapping application, and a second related notification is a new diagram or an updated diagram integrating notes associated with the first related notification.

Example 18: The method of example 1, wherein the first software application is an SMS application, a first related notification is a new SMS message, SMS read receipt, group updates, SMS delivery, SMS delivery failures, or spam alerts associated with a project, the second software application is a project management application, and a second related notification is a new task or calendar reminder, new activity, or collaboration alert associated with the first related notification.

Example 19: The method of example 1, wherein the first software application is a video conferencing application, a first related notification is a meeting reminder or invitation associated with a project, the second software application is an automated note-taking application, and a second related notification is a new note alert, note updated, note shared, or collaboration alert associated with the first related notification.

Example 20: The method of example 1, wherein the prioritizing based on the relation between and the disparate importance of notifications within the set of notifications uses a machine-learned model.

Example 21: The method of example 20, wherein the machine-learned model is built based on a history of user behavior.

Example 22: The method of any one of examples 1 to 21, wherein the prioritizing the set of notifications into the priority group is based on prior user selection associating the first and second applications to a project.

Example 23: A computer-readable storage media comprising instructions that, responsive to execution by a processor, cause the processor to perform any one of the methods of examples 1 to 22.

Example 24: An electronic computing device comprising at least one processor and computer-readable storage media comprising instructions that, responsive to execution by the at least one processor, direct the electronic computing device to perform any one of the methods of examples 1 to 22.

### Conclusion

Although implementations of techniques for, and apparatuses enabling, a multi-application user interface for prioritizing notifications have been described in language specific to features and/or methods, it is to be understood that the subject of the appended claims is not necessarily limited to the specific features or methods described. Rather, the specific features and methods are disclosed as example implementations enabling multi-application user interface for prioritizing notifications.

1. A method comprising:
receiving, at a user interface application associated with at least a first software application and a second software application, a set of notifications, the set of notifications including:
one or more first notifications associated with the first software application; and
one or more second notifications associated with the second software application;
prioritizing the set of notifications into a priority group, the priority group including two or more of the notifications in the set of notifications and excluding one or more of the notifications in the set of notifications, the prioritizing based on a relation between and a disparate importance of notifications within the set of notifications; and
presenting, by the user interface application and within a notification region of a user interface associated with the user interface application, the priority group of notifications.

2. The method of claim 1, wherein the notification region enables selection of one or more of the notifications of the priority group through the notification region.

3. The method of claim 2, responsive to selection of a selected notification of the notifications through the notification region, opening a software application of the first or second software application that is associated with the selected notification, and wherein opening the software application opens a notification user interface provided by the software application.

4. The method of claim 2, responsive to selection of a selected notification of the notifications through the notification region, presenting, within the user interface, additional information associated with the selected notification.

5. The method of claim 4, wherein the presenting the additional information associated with the selected notification includes presenting the additional information within a widget region within the user interface, the widget region associated with a software application that is associated with the selected notification.

6. The method of claim 3, further comprising visually highlighting a second region, the second region within the user interface and associated with the software application that is associated with the selected notification.

7. The method of claim 1, wherein the notifications of the set of notifications include an email, an SMS message or a text, information received through an application program interface (API), a push notification, a social-media like, a social-media mention, a tag, a calendar event, a missed video chat, or a missed phone call.

8. The method of claim 1, wherein the prioritizing based on the relation between and the disparate importance of notifications within the set of notifications is based on the relation between the notifications being related to a single project.

9. The method of claim 8, wherein the single project is a substance-based task associated with both the first and second software applications.

10. The method of claim 8, wherein the single project is determined based on a history of application usage by a user of the user interface, the history of application usage indicating greater use of the first and second software applications than of one or more other software applications also associated with the user interface and with which notifications of the set of notifications are associated.

11. The method of claim 8, wherein prioritizing the set of notifications into the priority group is based on prior user selection arranging the user interface, the prior user selection arranging the user interface selecting widgets for presentation on a home page of the user interface, the widgets associated with the first and second software applications.

12. The method of claim 1, wherein the prioritizing the set of notifications into the priority group based on the disparate importance of the notifications within the set of notifications is based on a due date to respond determined from within text of the notifications or metadata associated with the notifications.

13. The method of claim 1, wherein the prioritizing the set of notifications into the priority group is based on a machine-learned model, the machine-learned model determined based on a history of prior user behavior, the history of prior user behavior used as truth data to train the machine-learned model, the history of prior user behavior including multiple users not associated with a user of the user interface, the history of prior user behavior including at least selection history indicating selections through other priority groups of other user interfaces, the other user interfaces associated with the user interface application.

14. A computer-readable storage media comprising instructions that, when executed by one or more processors, configure at least one processor of the one or more processors to:
receive, at a user interface application associated with at least a first software application and a second software application, a set of notifications, the set of notifications including:
one or more first notifications associated with the first software application; and
one or more second notifications associated with the second software application;
prioritize the set of notifications into a priority group, the priority group including two or more of the notifications in the set of notifications and excluding one or more of the notifications in the set of notifications, the prioritization based on a relation between and a disparate importance of notifications within the set of notifications; and
present, by the user interface application and within a notification region of a user interface associated with the user interface application, the priority group of notifications.

15. (canceled)

16. The computer-readable storage media of claim 14, wherein the notification region enables selection of one or more of the notifications of the priority group through the notification region.

17. The computer-readable storage media of claim 16, wherein the instructions, when executed, further configure the at least one processor to, responsive to selection of a selected notification of the notifications through the notification region, open a software application of the first or second software application that is associated with the selected notification, and wherein opening the software application opens a notification user interface provided by the software application.

18. The computer-readable storage media of claim 16, wherein the instructions, when executed, further configure the at least one processor to, responsive to selection of a selected notification of the notifications through the notification region, present, within the user interface, additional information associated with the selected notification.

19. The computer-readable storage media of claim 14, wherein the notifications of the set of notifications include an email, an SMS message or a text, information received through an application program interface (API), a push notification, a social-media like, a social-media mention, a tag, a calendar event, a missed video chat, or a missed phone call.

20. The computer-readable storage media of claim 14, wherein the prioritizing based on the relation between and the disparate importance of notifications within the set of notifications is based on the relation between the notifications being related to a single project.

21. The computer-readable storage media of claim 14, wherein the prioritization of the set of notifications into the priority group is based on a machine-learned model, the machine-learned model determined based on a history of prior user behavior, the history of prior user behavior used as truth data to train the machine-learned model, the history of prior user behavior including multiple users not associated with a user of the user interface, the history of prior user behavior including at least selection history indicating selections through other priority groups of other user interfaces, the other user interfaces associated with the user interface application.
